(19) United States
(12) Patent Application Publication
(10) Pub. No.: US 2013/0251901 A1
(43) Pub. Date: Sep. 26, 2013

(54) Apparatus and Method for Coating Particulate Material

(71) Applicants: Stephen M. Loucks, Ames, IA (US); Robert J. Wampler, Ankeny, IA (US); Terry Potter, Ames, IA (US); Brent Packer, Ames, IA (US); David Roller, Kokomo, IN (US); Douglas Grunder, Mt. Vernon, IA (US)

(72) Inventors: Stephen M. Loucks, Ames, IA (US); Robert J. Wampler, Ankeny, IA (US); Terry Potter, Ames, IA (US); Brent Packer, Ames, IA (US); David Roller, Kokomo, IN (US); Douglas Grunder, Mt. Vernon, IA (US)

(73) Assignee: Becker Underwood, Inc., Ames, IA (US)

(21) Appl. No.: 13/494,479

(22) Filed: Jun. 12, 2012

Related U.S. Application Data
(60) Provisional application No. 61/615,574, filed on Mar. 26, 2012.

(51) Int. Cl. B05C 3/08; B05D 7/00

(52) U.S. Cl. 427/222; 118/612

(57) ABSTRACT

An apparatus and method are provided for coating a particulate material. A mixer defines a mixing chamber and receives a particulate material. An agitator includes a plurality of arms projecting radially outward from the shaft and a plurality of paddle blades positioned on the ends of the arms. The blades are formed such that the particulate material in the mixing chamber is directed in a rotational direction, a radially inward direction and an axial direction within the mixing chamber. A material feed system is provided for delivering a first coating material into the mixing chamber during rotation of the agitator, a polymer material during mixing of the coated particulate material and a reaction material for causing a reaction between the colorant feed and the polymer feed for creating an encapsulated particulate material.

### RELATED APPLICATION

The present application claims the benefit of the filing of U.S. Provisional Application No. 61/615,574, filed Mar. 26, 2012.

### FIELD OF THE INVENTION

The present disclosure relates to an apparatus and a method for coating a particulate material. The apparatus and the method may each in one form be applied to the coloring of particulate materials for use as a fill for artificial turf.

### BACKGROUND OF THE INVENTION

Athletic fields, such as football fields, soccer pitches, track, running tracks, playgrounds, “mini-golf” areas and other recreational fields are often covered in either natural turf (e.g., sod grass) or artificial turf. Artificial turf usually has a blade or projected fiber construction and often is supplemented by the addition of a base layer of ground cover that is interspersed or embedded among the blades or fibers. In the case of an athletic field, this base layer is capable of absorbing the energy of impact of feet or other body parts making contact with the turf surface. These ground covers may include any number of types and sizes of particulate material, with examples including sand, rubber or rubberized materials. For aesthetic reasons, it may be desirable for the supporting particulate material to be colored green to mimic the look of natural turf, or may be otherwise colored to create a desired appearance.

In other circumstances, a particulate material may be used as an independent ground cover or surface material. Such ground cover materials may be selected from a variety of particulates, including, sand, rubber or rubberized materials, pebbles, wood or other mulch materials, etc. Again, for aesthetic reasons, it may be desirable for the material to be colored to mimic the look of natural material or may be otherwise colored to create a desired appearance.

If the selected material is a rubber, the ground cover material may be made of chunk or crumb sized particles. Such materials may be derived from the recycling of automotive and truck scrap tires. For example, in the case of crumb rubber, it may be prepared by removing the steel and fluff portions, leaving the tire rubber with a particulate consistency. The rubber may be further processed with a granulator and/or cracker mill to reduce the size of the particles. Different sized particles may be used depending on the end application. Chunk rubber is typically larger than ½ inch in diameter or along one side, while crumb rubber is typically smaller than ⅜ inch. Other forms and dimensions are possible.

The presently contemplated particulate materials have in some circumstances been found to contain metals or other materials that may leach into the surrounding environment and/or emit volatile organic compounds (VOCs). The potential long term effects on the environment and/or the individuals who come in contact with these potentially dangerous or toxic materials have recently become a concern. An environmentally friendly, green-colored coating for application to artificial turf or other substrates that serves as a barrier to VOCs and metal leachates is described in Oien et al, US 2011/0086228; the disclosure therein being herein incorporated by reference.

Apparatus and methods for coating landscaping materials and particulate ground cover materials are known. Winistorfer et al, U.S. Pat. No. 6,551,401, shows and describes a machine for coloring landscaping materials, such as wood mulch and the like. The apparatus in this Winistopher et al patent may be used for continuous mixing of the colorant with the mulch material within a multistage mixing bowl. The disclosure in this prior patent is also incorporated herein by reference.

Greenberg et al, U.S. Pat. No. 5,910,514, describes a colored rubber material formed to simulate wood mulch. Rondy, U.S. Pat. No. 5,192,587, describes the use of a continuous auger screw within an angled trough for applying colorant to a wood mulch material. Other apparatus and methods are known for coating of materials, including wood mulch and rubber particulate material. Various methods may be performed as a continuous process or on a batch basis.

### SUMMARY OF THE INVENTION

The present disclosure relates to an apparatus and a method for coating a particulate material. A mixer defines a mixing chamber and receives a particulate material. An agitator includes a plurality of arms projecting radially outward from the shaft and a plurality of paddle blades positioned on the ends of the arms. The blades are formed such that the particulate material in the mixing chamber is directed in a rotational direction, a radially inward direction and an axial direction within the mixing chamber. A material feed system is provided for delivering a first coating material into the mixing chamber during rotation of the agitator, a polymer material during mixing of the coated particulate material and a reaction material for causing a reaction between the colorant feed and the polymer feed for creating a coated particulate material.

in a further aspect of the present disclosure is defined by a mixer having a defined mixing chamber. Means is provided for directing a quantity of particulate material into the mixing chamber. An agitator is provided in the mixing chamber having a shaft mounted for rotation, a plurality of arms projecting radially outward from the shaft, and a plurality of paddle blades. The blades are positioned on the ends of the projecting arms and are formed such that during rotation of the shaft the particulate material is directed in a rotational direction, a radially inward direction and an axial direction within the mixing chamber. A material feed system is provided and communicates with the mixing chamber. The feed system includes a coating feed for delivery of a first coating material into the mixing chamber during rotation of the agitator and mixing by the rotating paddle blades. A polymer feed is provided for delivery of a polymer material into the mixing chamber during rotation of the agitator and mixing of the coated particulate material. A reaction material is provided for causing a chemical drying reaction between the colorant feed and the polymer feed and for creating a coated particulate material. Means is further provided for discharging the encapsulated particulate material from the mixing chamber.

In a further aspect of the apparatus the coating feed and the reaction feed may be combined so as to deliver the first coating material and a reaction material in to the mixing chamber at the same time.

In a further aspect of the apparatus the plurality of agitator blades may be directed at varying angles with respect to the agitator shaft. Further, the agitator blades may be positioned at multiple radial positions relative to the agitator shaft.

In a further aspect of the apparatus, the polymer feed material may comprise a polyurethane pre-polymer. Further, the reaction material may comprise a catalyst for reacting with the polymer material to create the chemical drying.

In a further aspect of the apparatus, the mixing chamber may be defined by an elongated mixer bowl having a longitudinal axis and at least a portion of an inside surface if the bowl defining a cylindrical surface surrounding the axis. Further, the shaft of the agitator may be aligned along the axis of the bowl and at least a portion of the blades are positioned adjacent the inside surface of the bowl and rotated in a closely spaced relationship with the inside bowl wall.

In a further aspect of the present disclosure a method of coating a particulate material includes the steps of providing a mixing chamber; feeding a particulate material into the mixing chamber; agitating the particulate material within the mixing chamber; mixing the first coating material with the particulate feed material to create a first coating on the particulate; mixing a reaction catalyst with the coated particulate material; and mixing a pre-polymer material with the catalyst and the coated particulate material. The catalyst and pre-polymer of the method are selected to form a reaction to create chemical drying of the mixed first coating, catalyst and pre-polymer and to form a polyurethane coating that encapsulates the particulate material.

In a further aspect of the method, the mixing of the reaction catalyst with the first coating material may occur prior to the mixing of the first coating material with the particulate material. Further an additional reaction catalyst may be provided while mixing the pre-polymer material with the coated particulate material.

In a further aspect of the method, the agitating of the particulate material and the mixing of the first coating material with the particulate material may be performed by a plurality of agitator blades rotating within the mixing chamber. Further, the agitator blades may be directed at varying angles with respect to a rotating agitator shaft. The agitator blades may be positioned at multiple radial positions relative to the agitator shaft.

In a further aspect of the method, the mixing chamber may be defined by an elongated mixer bowl having a longitudinal axis and at least a portion of an inside surface if the bowl defining a cylindrical surface surrounding the axis. Further, the shaft of the agitator may be aligned along the axis of the mixer bowl. In addition, at least a portion of the blades may be positioned adjacent the inside surface of the bowl and are rotated in a closely spaced relationship with the inside bowl wall.

Other features of the present invention and combinations of features will become apparent from the detailed description to follow, taken in conjunction with the accompanying drawings.

### BRIEF DESCRIPTION OF THE DRAWINGS

For the purpose of illustrating the invention, the drawings show forms that are presently preferred. It should be understood that the invention is not limited to the precise arrangements and instrumentalities shown in the drawings.

FIG. 1 shows an embodiment of an apparatus for performing a method contemplated by the present disclosure.

FIG. 2 shows a mixing bowl portion of the apparatus of FIG. 1, with certain structures removed for illustration purposes, and the mixing bowl being shown in a feed position.

FIG. 3 shows the mixing bowl portion of the apparatus of FIGS. 1 and 2, with the mixing bowl being shown in a mixing position.

FIG. 4 shows the mixing bowl portion of the apparatus of FIGS. 1-3, with the mixing bowl being shown in a discharge position.

FIG. 5 shows the mixing bowl portion of the apparatus of FIGS. 1-4, with the mixing bowl being shown in an inspection position.

FIG. 6 shows a side elevation view of a positional break for the mixing bowl portion of the apparatus of FIG. 1.

FIG. 7 shows a front elevation view and partial angled view of the positional break portion of FIG. 6.

FIG. 8 shows a side elevation view of the mixing bowl portion of the apparatus of FIG. 1, with the mixing bowl being shown in the mixing position of FIG. 3.

FIG. 9 shows a top plan view of the mixing bowl cover plate and its associated plenum structures.

FIG. 10A shows a side view of the cover plate of FIG. 9 in the closed position relative to the mixing bowl opening.

FIG. 10B shows a side view of the cover plate of FIG. 9 in the open position relative to the mixing bowl opening.

FIG. 11 shows an angled view of the mixing bowl of the apparatus of FIG. 1, with certain internal structures shown in phantom.

FIG. 12 shows an alternate angled view of the mixing bowl of the apparatus of FIG. 1, with certain internal structures shown in phantom.

FIG. 13 shows a front elevation view of the mixing bowl portion of the apparatus of FIG. 1, with certain internal structures shown in phantom.

### DETAILED DESCRIPTION

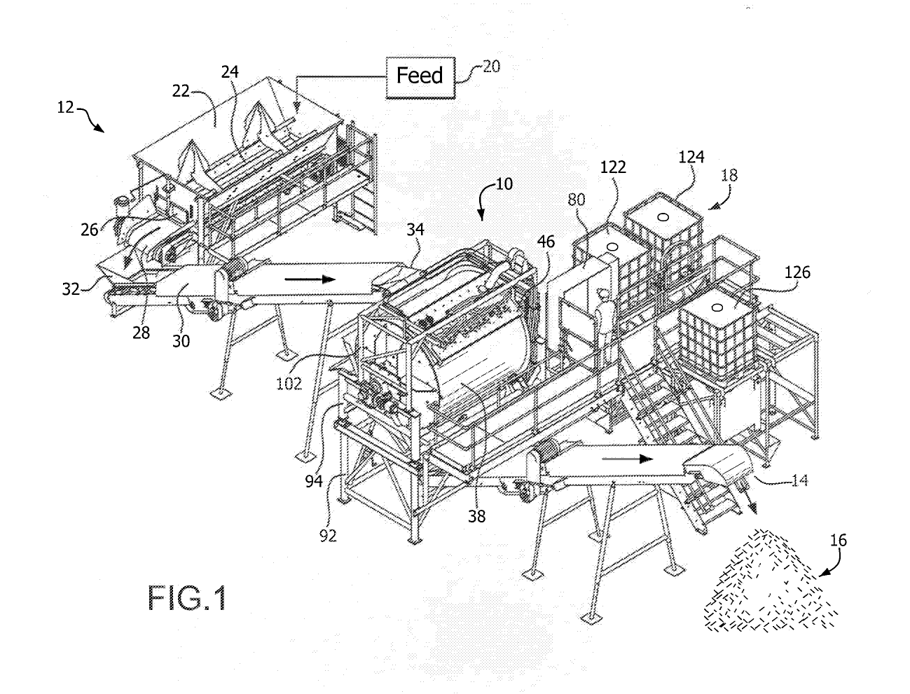

In the figures, where like numerals identify like elements, there is shown an embodiment of various machinery for performing a process for mixing particulate material with a coating, preferably including a colorant. The mixing apparatus is designated generally by the numeral 10 in FIG. 1 and, as illustrated, is defined as a batch mixer. The mixer 10 is preceded by feed means 12 for delivering raw particulate material to the mixer 10. A coating feed means 18 also communicates with the mixer 10 and directs the constituent parts of the coating to the particulate material within the mixer 10. A discharge means 14 is provided downstream of the mixer 10 to move the coated particulate material away from the mixer 10 and direct it for further processing. The discharge means 14 is shown as depositing the finished product into a pile 16 for initial storage prior to packaging or other distribution. Other processing steps, packaging operations or storage methods may be utilized or added, as desired.

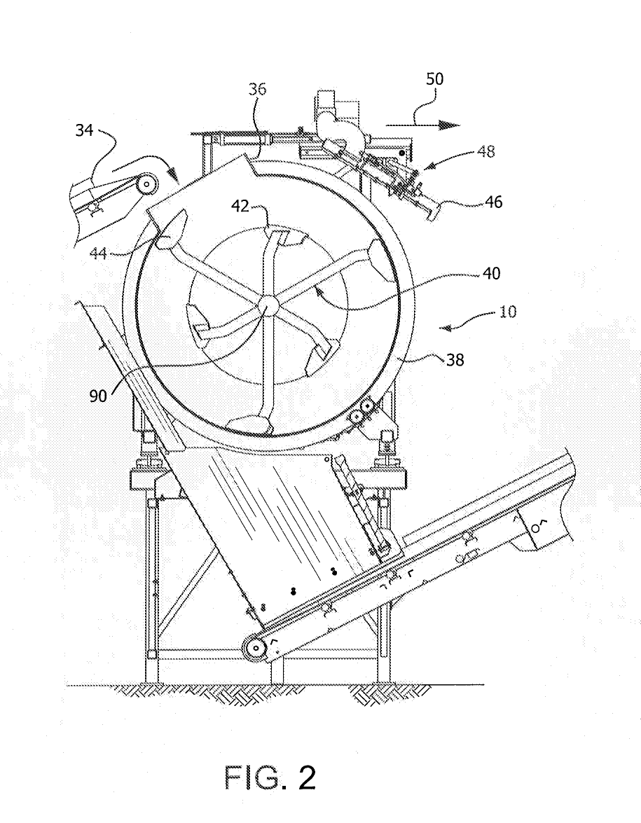

In the feed means 12 of the machinery, the particulate feed 20 is initially directed into a surge hopper 22. The feed 20 may include any number of materials, such as sand, wood mulch, chipped or crumb rubber or plastic materials. The feed 20 may be loaded into the surge hopper 22 in any number of ways. It is contemplated that the particulate feed 20 will be stored in bulk and loaded, such as by a front end loader (not shown), into the top of the surge hopper 22. The surge hopper 22 may include a number of means for spreading and controlling the flow of particulate. A conveyor structure 24 is shown in the base of the surge hopper 22 to direct the particulate to a discharge opening 26 at one end of the hopper 22. The conveyor end 28 extends past the discharge opening 26 and moved the particulate onto the base 32 of an angled feed conveyor 30. The discharge opening 26 may be opened and closed to control the flow of particulate feed from the surge hopper 22 to the angled conveyor 30. The angled conveyor 30 moves the feed material from the surge hopper 22 to the mixer 10. The base 32 of the angled conveyor 30 is positioned relatively below the top 34 of the conveyor 30. The top end 34 of the conveyor is positioned adjacent a mixer opening 36, when the mixer 10 is in the feed position, as shown in FIG. 2.

The bowl 38 is illustrated in FIGS. 2-5 in various rotated positions about its central axis. Means is provided for causing rotation of the bowl 38. Means is further provided for fixing the position of the bowl within the operative positions. These means for positioning the bowl are discussed further below. In FIG. 2, the feed position of the mixer 10 is shown. The mixer bowl 38 is shown in partial cross section with the bowl opening 36 positioned adjacent the top 34 of the angled conveyor 24. The opening 36 defines a feed means for the mixer and communicates with the interior of the bowl 38. The bowl 38 defines a mixing chamber that is generally cylindrical. An agitator 40 is provided at the center of the bowl 38 and aligns along the longitudinal axis of the bowl. As shown, the agitator 40 includes both inside agitator blades 42 and outside agitator blades 44, each operating at different radial positions within the bowl 38. A separate rotation means for the agitator is provided on the mixer 10 and is discussed further below. A cover plate 46 is provided adjacent the bowl 38 and is movable into and out of an engagement position. In FIG. 2, the cover plate 46 is shown in a non-engaged position as represented by the arrow 50. The cover plate 46 includes a plurality of feed manifolds 48 for directing coating materials or drying gas into the bowl.

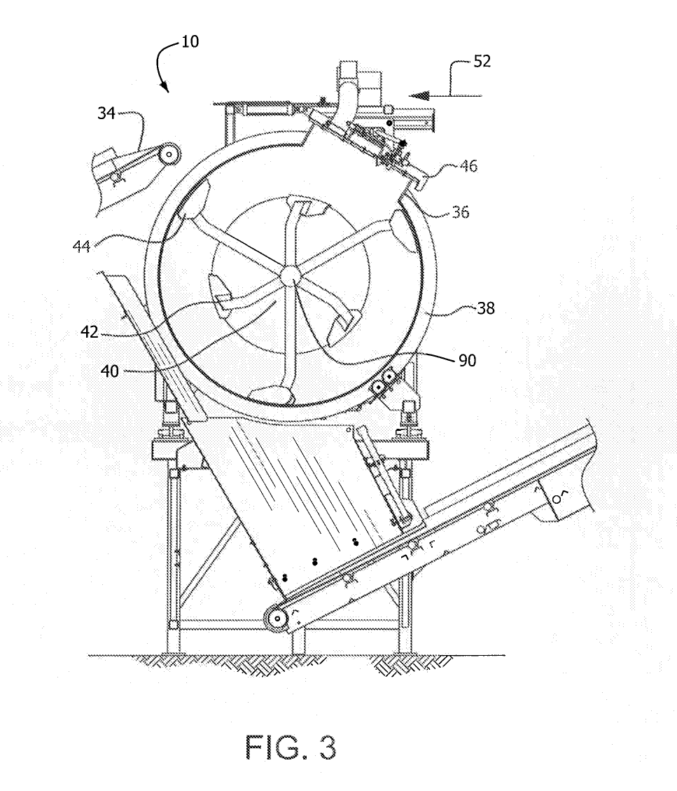

In FIG. 3, the mixer 10 is shown in the mixing position, with the mixer opening 36 rotated away from the feed position (FIG. 2) and engaged with the cover plate 46. The mixer bowl 38 is rotated about its axis and held in the mixing position and the cover plate 46 is moved into engagement as illustrated by arrow 52.

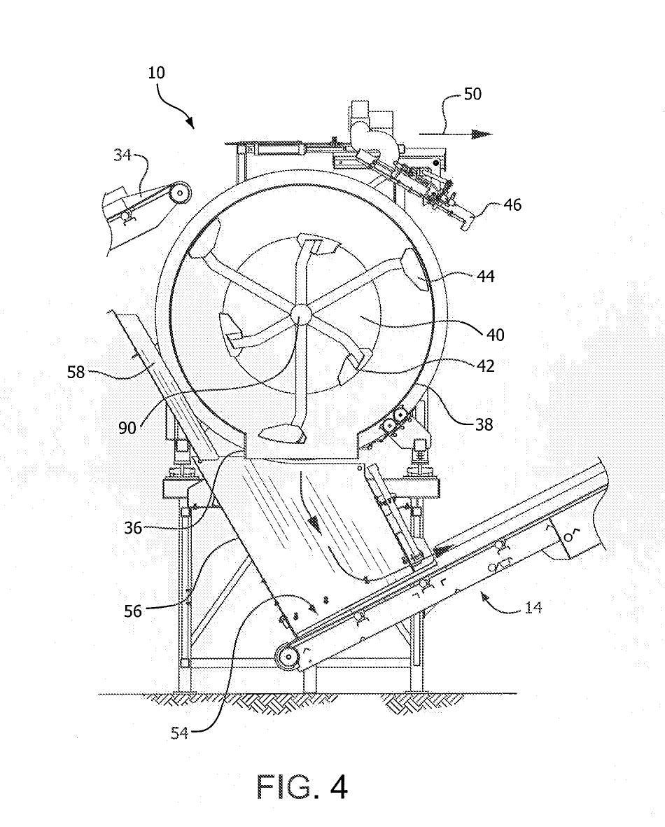

In FIG. 4, the mixer 10 is shown in the discharge position, with the mixer opening 36 rotated to the bottom and open to the discharge means 14. In this position, the rotation of the bowl 38, the rotation of the agitator 40 and position of the bowl 38 define a discharge means for the mixer. The cover plate 46 is shown in the out-of-engagement position, as represented by the arrow 50. The discharge means 14 is shown as being a second angled conveyor 60, with the base 54 being provided below the bowl 38. The processed particulate is directed from the bowl 38, through the mixer opening 36 and into the receiving hopper 56 at the base 54 of the conveyor 60. A shield 58 is provided above the hopper 56 and adjacent the outside surface of the bowl 38. As the mixer opening 36 moves (counterclockwise) from the mixing position (FIG. 3) to the discharge position (FIG. 4), the shield 58 may loose catch material projected out of the opening 36 during bowl rotation. The shield 58 directs the loose material downwardly into the hopper 56. The discharge conveyor 60 angles upwardly from the base 54.

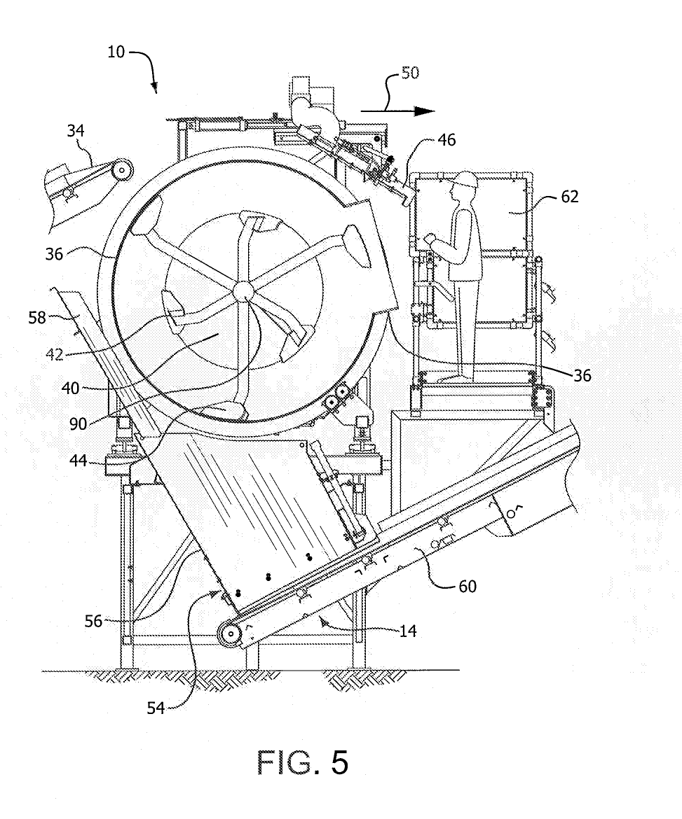

In FIG. 5, the mixer 10 is shown in the inspection position, with the bowl 38 rotated adjacent an inspection station 62. The cover plate 46 is shown in the out-of-engagement position as represented by arrow 50. The inspection position provides access to the interior of the bowl 38, including the agitator 40 and its blades 42, 44.

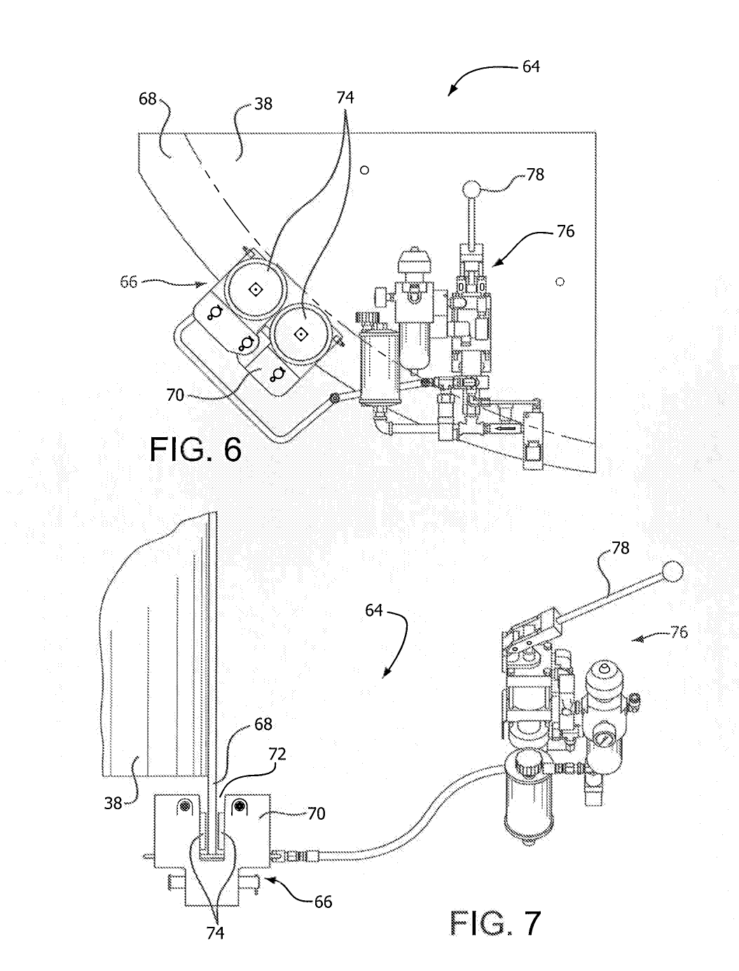

In FIGS. 6 and 7, there is shown a means 64 for fixing the rotated position of the mixer bowl 38. The fixing means 64 generally comprises a brake 66 that engages a flange 68 fixed to the outside surface of the bowl 38. The brake 66 is composed of a caliper 70 having a u-shaped channel 72 therein with brake pads 74 positioned on opposing sides of the channel 72, with the bowl flange 68 positioned between the pads 74. A hydraulic piston 76 feeds fluid to the caliper 72 to control activation of the brake pads 74 into engagement with the bowl flange 68. An activation lever 78 is provided on the piston apparatus 72 for manual control of engagement of the pads 74 with the flange 68. One source for dual disk brakes of the type illustrated is Tolomatic, Inc. of Hamel, Minn. A system controller 80 (see FIG. 1) may also be programmed to activate the brake 66. In operation, the fixing means 64 is engaged upon setting the desired position of the bowl 38 (see FIGS. 2-5) to fix the bowl 38 in it operative position.

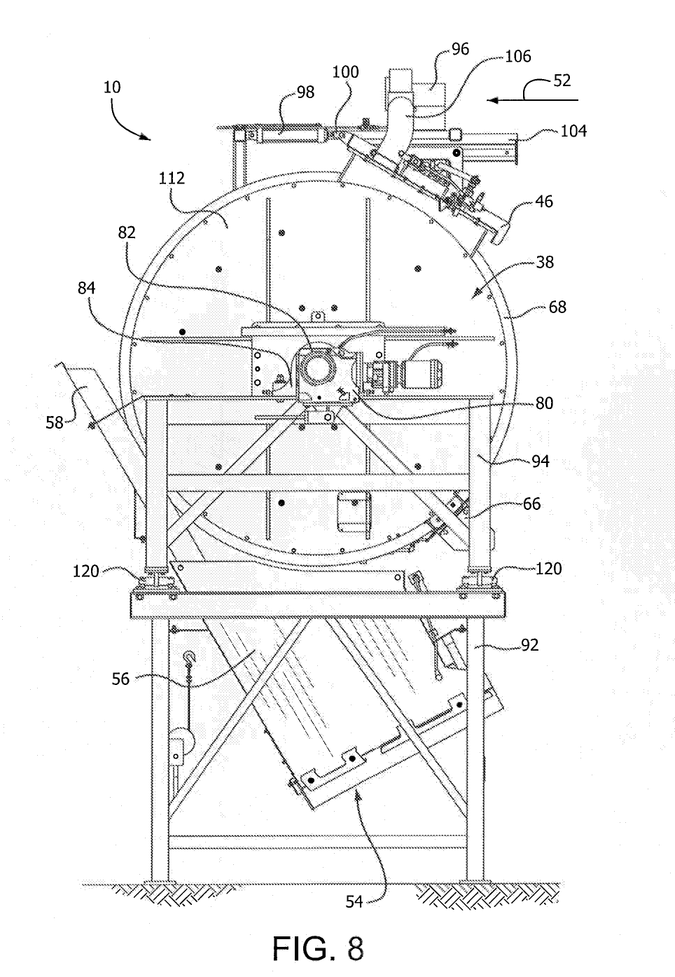

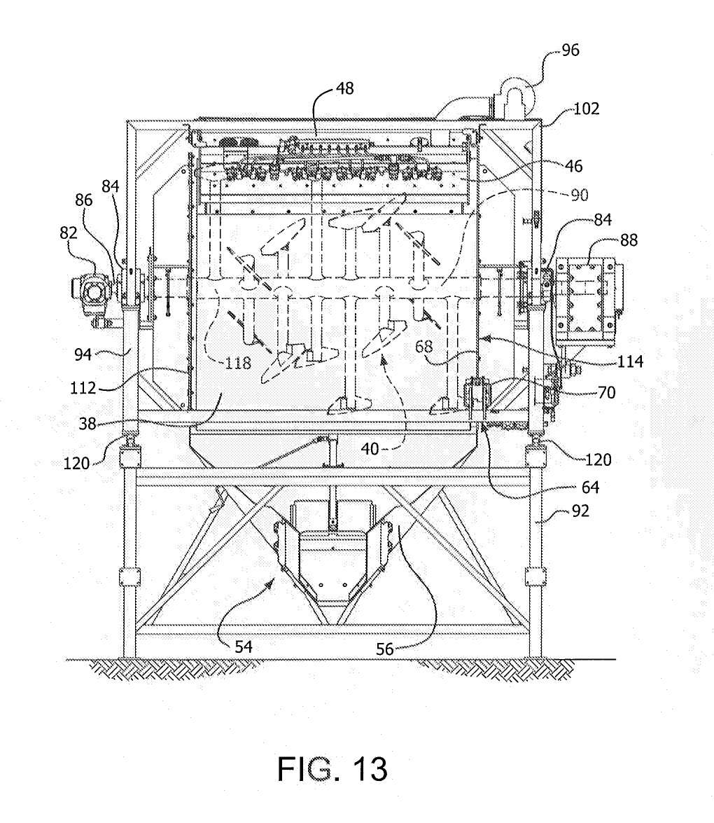

A bowl drive motor 82 is shown in FIG. 8 and is connected to the bowl 38 via a connecting shaft 86 (see FIG. 13). The bowl drive 82 is used to rotate the bowl 38 to the various operative positions (FIGS. 2-5). A separate agitator drive motor 88 (see FIG. 13) is provided to rotate the agitator shaft 90 and the connected agitator 40. As shown, the mixing of the particulate feed and the coating materials is performed while the bowl 38 is stationary (i.e., not rotating), as set by the fixing means 64. The system controller 80 and appropriate sensors (not shown) are used to identify the rotated position of the bowl 38. The controller 80 may set the bowl drive 82 to rotate the bowl 38 a fixed amount. The controller 80 may also control the fixing means 64 during rotation of the bowl or the fixing means 64 may serve solely to lock the bowl 38 once it reached the desired position. The bowl drive motor 82 is contemplated to be smaller in size than the agitator drive 88. For example, a 2 HP motor for rotation, of the bowl to its desired operational positions may be sufficient, while a 50 HP motor may be required for agitator rotation. It is noted that rotation of the agitator 40 may occur during rotation of the bowl 38 by means of drive 82. When the bowl includes particulate material and/or coating chemicals therein, the rotation of the agitator will assist in rotation of the bowl. The bowl drive 82 and agitator drive 88 are contemplated to operate in either rotational direction. Although the bowl 38 may be permitted to rotate a full 360 degrees, it is contemplated that rotation would occur only between the end points of the missing position (FIG. 3) and the inspection position (FIG. 5), while passing through the feed position (FIG. 2) and the discharge position (FIG. 4). A gear reduction and torque arms are also contemplated for efficient operation of the mixer 10. Other drive forms are possible including the use of a chain drive and/or shifting transmissions.

In FIG. 8, the mixer 10 is shown mounted on a base frame 92, which surrounds the discharge conveyor base 54 and the receiving hopper 56. A support frame 94 is positioned on the base frame 92 and supports the mixer bowl 38 and associated hardware, including the bowl drive 82 (and the agitator drive 88 as shown in FIG. 13). The brake 66 is fixed to the support frame 94 and the bowl shaft 86 is supported by bearings 84 at each end (see also FIG. 13). As shown in FIG. 8, the bowl 38 is rotated to the mixing position, as is also shown in cross section in FIG. 3, with the opening 36 closed by the cover plate 46. As indicated by arrow 52, the cover plate is moved to the engagement position.

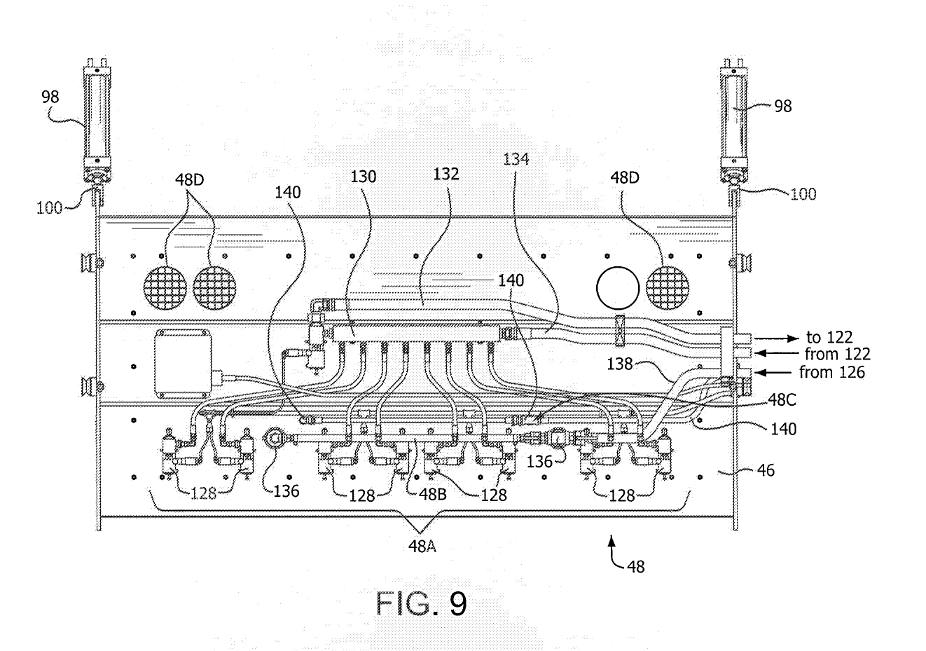

Details of the cover plate 46 are shown in FIG. 9, which is a top plan view of the cover plate 46 showing means for feeding various components of the coating materials into the mixer bowl 38. Various feed manifolds 48 are positioned on the cover plate 46. Three liquid manifolds 48A, 48B, 48C are designated for directing various coating materials into the bowl, when the plate 46 is engaged with the bowl opening 36 (see FIGS. 3 and 8).

As shown, manifold 48A is provided to direct the polyurethane pre-polymer into the bowl. The manifold is formed by a plurality of nozzles 128 provided a spaced positions along the length of the cover plate 46 (and, thus, the length of the bowl). In FIG. 9, eight nozzles are shown, with each being fed from a common valve assembly 130. The valve assemble 130 is provided to control the recirculation of the pre-polymer material during other operational steps. The valve assembly 130 is normally open, preventing the pre-polymer material from being directed into the nozzles 128. However, a certain pumping force is provide to maintain a flow of material from the valve 130 to a return line 132, which is directed back to the storage means 122 (FIG. 1). The feed line 134 also connects the storage means 122 to the valve assembly 130. When the valve 130 is closed, pre-polymer material flows to the nozzles and is sprayed into the bowl 38. The nozzles for feed of the pre-polymer material may be ¼ inch SCP valve nozzles from Adhesive Systems Technology Corp of Minneapolis, Minn. Such nozzles may have an auto closing feature and may further be sealed by a grease packing material during shut down of the mixer.

The second manifold 48B is designated for introducing the first coating material or colorant into the mixer bowl. As shown, two nozzles 136 are provided from directing liquid into the bowl 38. The nozzles are connected to a feed pipe 138, which is feed from the colorant storage means 126 (FIG. 1). As discussed further herein, it is contemplated that the flow of the first coating material into the bowl 38 may be at a relatively high rate and does not create by itself a buildup problem upon introduction into the mix.

The third manifold 48C is provided for introduction of a reaction means or catalyst into the bowl to assist in the curing process for the colorant and pre-polymer materials. The catalyst flow is directed into the bowls through nozzles 140, which are fed by feed line 142 that in turn communicates with storage means 124 (FIG. 1). Additional feed lines are shown. These feed lines may be provided for directing water into the bowl 38 or an additional gas into the bowl or to assist in the flow of the liquid material through the nozzles. For example, forced air may be used to actuate the pre-polymer nozzles 128 and/or the catalyst nozzles 140.

Openings 48D are provided in the cover plate for directing gas into or withdrawing gas out of the bowl 38. As shown, the gas blower 96 (See FIG. 8) is connected to the cover plate 46 at an opening 48D on one side of the cover plate 46. The blower serves to input gas into the bowl during the drying step, or otherwise, while the opposite side openings 48D serve as a gas exhaust. Flexible hosing is provided between the blower 96 (see, e.g., hose 106 in FIG. 8) and its mounting position on the opening 48D on the cover plate 46. Other flexible connections (not shown) may connect the coating feed means 18 and the various manifolds 48A, 48B, 48C to allow from movement of the cover plate 46.

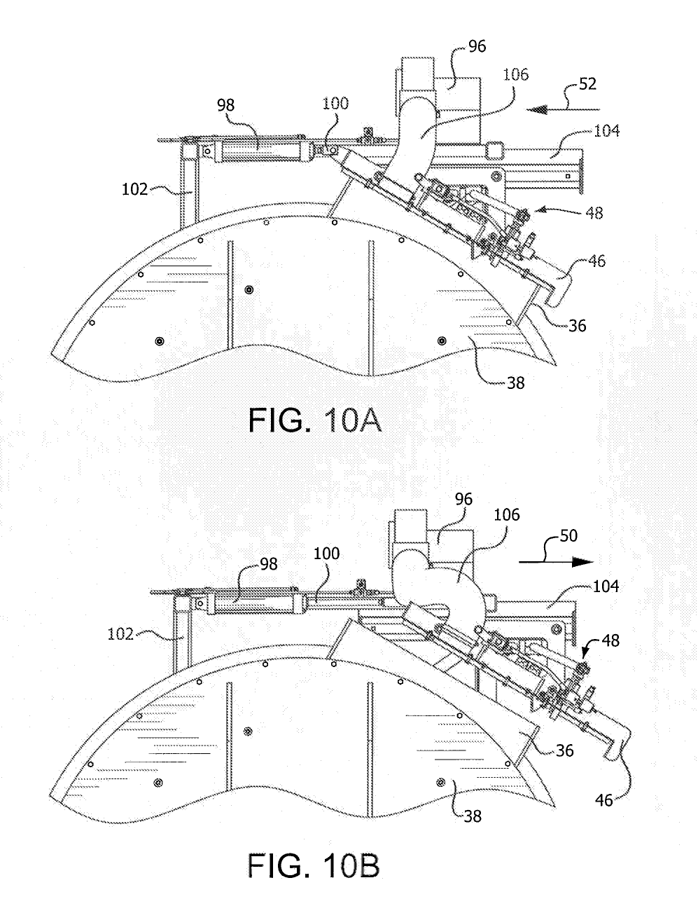

In FIGS. 10A and 10B, there is shown the movement of the cover plate 46 into and out of engagement with the mixer bowl 30. In FIG. 10A, the bowl 38 is provided in the mixing position, with the bowl opening 36 adjacent the cover plate 46. The cover plate is brought into engagement with the opening 36 as represented by arrow 52. Movement of the cover plate 46 is created by pistons 98 (see also FIG. 9) connected by linkage 100 to the plate 46. The pistons are supported on a cover frame 102, which is supported on the bowl support frame 94 (see FIG. 13). The cover plate is further supported on linear tracks 104, to control travel of the plate 46. In FIG. 10B, the cover plate is disengaged from the opening 36 of the mixer bowl 38 as represented by arrow 50. The shafts of pistons 98 extend outward to drive the linkage 100 and the plate 46 away from the bowl 38. As shown, the blower 96 is connected to the plate by hose 106, which flexes to allow for relative movement of the plate with respect to the blower 96. Similar flexible connections are made with the manifolds 48A, 48B, 48C and the coating feed means (18). Once the cover plate 46 is separated from the opening 36, the mixer bowl may rotate about its axis to another operational position (as shown by, e.g., FIGS. 2-5).

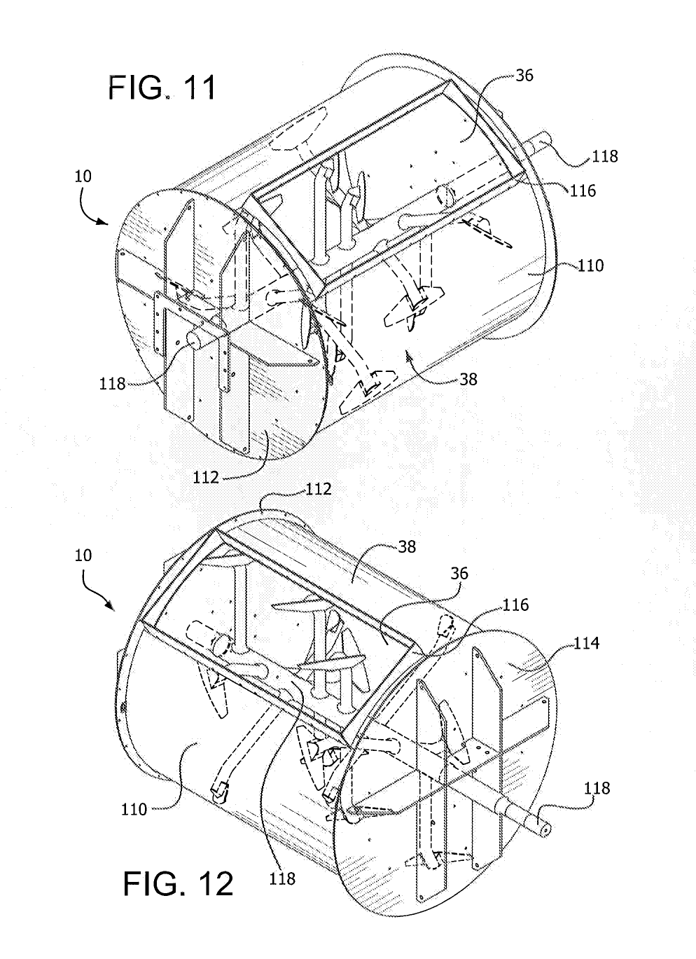

FIGS. 11 and 12 show various external and internal structures of the mixer 10. The bowl 38 includes a hollow, cylindrical body 110 and two end plates 112, 114. The bowl opening 36 is defined by a projecting rim 116. The agitator 40 is supported within the center of the bowl body 110, with agitator shaft 118 positioned along the axis of the bowl 38. The shaft 118 extends outwardly from both end plates 112, 114. One end of the shaft is connected to the agitator drive 88, positioned adjacent the end plate 114. The other shaft end projects from the end plate 112 adjacent the bowl drive 82. As shown in FIG. 13, bearings 84 support the ends of the agitator shaft 118. Multiple bearings are contemplated to be included to support both the agitator 88 and the bowl shaft 86. As also shown in FIG. 13, the brake flange 68 for the fixing means 64 and its associated caliper 70 are provided on end plate 114, although the flange may be provided on the opposing end plate or a fixing mean of another form may be provided for holding the bowl in a desired rotated position.

As shown in FIGS. 8 and 13, the bowl support frame 94 is mounted on the base frame 92. A plurality of load cells 120 are provided under the posts of bowl frame 94 and are supported by the adjacent portions of the base frame 92. The load cells serve to measure the weight of the bowl 38 and its contents for purposes of controlling the particulate feed and the coating process. The load cells 120 are connected to the system controller 80, which in turn controls the operation of the particulate feed means 12, rotation of the agitator 40, position of the mixer bowl 38, the addition of coating materials through the manifolds 48, the discharge means 16, etc. The load cells may take the form of model WM-II (No. 70210) as sold by Artech Industries, Inc. (Riverside, Calif.). These specific load cells are designed for double ended beams in tank weighing. Other weight measuring devices may be utilized.

In operation, the feed particulate material 20 is loaded into the surge hopper 22, while its conveyor 24 is running. The internal structures of the surge hopper 22 and its metering means at the discharge opening 26 direct a relatively controlled flow of particulate onto the angled conveyor 30. The angled conveyor 30 moves the particulate feed to the bowl 38 and directs the feed into the bowl opening 36, which is set in the feed position of FIG. 2. The load cells 120 serve to measure the weight of the particulate within the bowl 38. Upon reaching a predetermined load, the system controller 80 turns off the conveyor 24 in the surge hopper 22 and the angled conveyor 30. Hence, the feed into the bowl 38 is stopped. A signal is sent to the brake 66, such that the caliper 70 releases from engagement of the bowl disk 68. A further signal from the system controller 80 causes the bowl drive motor 82 rotated the bowl 38 from the feed position of FIG. 2 to the mixing position of FIG. 3. A further signal directs the cover plate 46 into engagement (arrow 52, FIG. 10B) with the bowl opening 36. The agitator 40 may be rotated at various times and speeds to assist in the feed and bowl rotation. For example, it is contemplated that rotation of the agitator during the particulate feed will assist in effective distribution of particulate material throughout the bowl and in effect speed up the feed portion of the process.

When the bowl 38 is ready (FIG. 3) for mixing of the particulate material with the coating chemicals, the load cells 120 may again be utilized to measure the quantities of the coating chemicals, and the like, added to the bowl 38. The coating feed means 18 includes one or more pumps that are controlled by the system controller SO, which in turn responds to signals generated by the load cells 120.

A plurality of storage means 122, 124, 126 (see FIG. 1) are provided for retaining constituent parts of the coating to be applied to the particulate retained with in the mixer bowl 38. The controller 80 starts a pump that feeds coating chemicals from one or more of the storage means 122, 124, 126 into a correspond manifold 48A, 48B, 48C on the cover plate 46 (see FIG. 9). A diaphragm pump is contemplated for directing the coating chemicals from storage to the bowl. The cut off signal from the controller 80 may take into account the typical amount of continued flow of material from the manifold after the pump is stopped. Hence, the control signal may take into account the actual measured weight determined from the four load cell signals and the predicted flow after pump stop in fixing the desired amount of the coating chemical introduced into the bowl. A more detailed description of coating materials and processes, useful with the apparatus herein described, are provided below.

The agitator 40 as shown in various figures includes a series of inside blades 42 rotating at an inner radius position within the mixer bowl 38 and a series of outside blades 44 rotating at an outer radius position relatively close to the inside surface of the bowl 38. The blades 42, 44 are attached to a common shaft 90 positioned co-axial with the bowl axis. Each of the blades has a paddle portion positioned on the projected end of a blade shaft. The blade shafts include a kink or bend at about their midsection. The paddle ends include a relatively broad face and an outer lip. The kink in the blade shaft and the form of the paddle end are intended to create a lifting of the particulate material within the bowl. The blades 42, 44 are located at various positions along the length of the shaft 90 within the mixer bowl 38 (see, e.g., FIGS. 11-13). The kink in the blade shaft and the lip on the paddle portions serve to create a radially inward or lifting movement to the particulate. Further, the paddle ends are directed a various axial angles to move the particulate in multiple axial directions within the bowl. The two blade series 42, 44 serve to agitate the particulate material at multiple levels to provide a better mixing action. The position of the outside blades 44 is contemplated to pass along the linear length of the entire cylindrical surface of the bowl 38.

The form of the agitator blades 42, 44 is contemplated to impart rotational motion to the particulate. In addition, the agitator blades impart a motion to the particulate in directions both parallel (axial) and perpendicular (radial) relative to the shaft 90 of the agitator 40. At relatively higher rotational speeds, a scrubbing or rubbing action for the particulate and coating chemicals may be created, assisting in the mixing of the coating materials. Other blade styles and agitator forms may also be used along with the contemplated coating process and coating materials. The agitator 40 is contemplated to be made of steel and be coated or otherwise formed to resist adherence of the coating chemicals. The blade shafts and agitator shaft are welded together with a high degree of finishing of the joints being provided.

A liner may be included in the bowl for protection of the bowl wall and to make the mixer resistant to buildup of coating material. The liner may be a single sheet of material that is formed or positioned into engagement with the bowl wall. Brackets may be provided at the mixer opening 36 to secure the one piece liner to the inside surface of the bowl. Clearance is provided between the liner and the agitator blades 44, which are the blades positioned closest to the bowl wall. End liners may also be fastened on to the end plates 112, 114. These end liners may have a single piece construction or may be assembled from multiple parts. Fasteners are contemplated to secure the end liners to the end plates. The fasteners preferably are countersunk into the material of the end liners (or the bowl liner) to provide a relatively smooth interior surface. One possible liner material may be ultra-high-molecular-weight polyethylene (UHMW).

A variety of sensors may be included in the mixer 10 and the other components that serve to control overall operation, preferably through a programmable logic controller (PLC) or similar device within the system controller 80. For example, sensors may be provided to continuously determine the rotational position of the agitator shaft 90 with logic to determine the position of the paddles relative to the manifolds 48 on the cover plate 46. Because of the potential adhesive nature of some materials that may be used in coating the particulate, it may be advantageous to sequence the fluid delivery (by means of a spray, jet, etc.) into the mixer bowl 38 and to discontinued delivery at the time when the paddle portions of the agitator blades 42, 44 are in proximity to the nozzle outlets of the manifolds 48 on the cover plate 46. Proximity sensors may be utilized separately or in conjunction with the positional locators for the rotation of the agitator shaft. The sensors signals serve to cut off flow through the nozzles (or the like) approximately 2 times per revolution. This nozzle control may be applied at all times during the coating process or may occur only when adding certain materials which may cause adhesion to the agitator blades (or similar structures).

As discussed in more detail below, a polyurethane pre-polymer material may be used in the coating process contemplated. The nozzles (128, see FIG. 9) for directing this material into the mixer bowl 38 from the manifold (48A, see FIG. 9) on the cover plate 46 may be standard polyurethane nozzles of the type without an included needle valve at the output end. Such nozzles forms are defined by a nozzle opening having a specific length and width. The polyurethane pre-polymer material will typically not “drip” from the nozzle, depending on viscosity.

It is contemplated that the coating feed means 18 may include heating means to control the temperature of the pre-polymer (or other) coating chemicals during processing, where control of the viscosity, temperature or other characteristic of the material is desired. The heating means may take the form of a heating blanket wrapped around the storage container for the pre-polymer material. Such a blanket may be a Powerblanket® product as sold by Powerblanket, LLC of Salt Lake City, Utah. In use, the pre-polymer material has been found to have acceptable flow characteristics when maintained at a temperature of 90 degrees Fahrenheit, although other temperatures and conditions may be applied and found acceptable.

Further, the feed of pre-polymer (or other coating chemicals) may be defined by a closed loop, where a certain pressure is required for the material to be directed into the nozzle portion of the manifold. The material will be directed into a return loop and feed back into the storage means 122, 124 or 126, unless the valve is closed. The heating may be a heating blanket wrapped around one of the storage means containing the pre-polymer. A nitrogen gas may be directed into the storage means to seal the material in an uncured state during periods between coating operations. The material may also cure at the nozzle (128, FIG. 9) to temporarily seal the nozzle during operation. Pressure from the feed pump to the fees line (134, FIG. 9) may also be used to purge the temporary seal. A sealing grease or petroleum jelly may be applied to the nozzles to maintain the feed lines closed for longer periods, such as while the mixer is out of use.

As shown in FIG. 1, the discharge means 14 deposits the finished product into a pile 16 for initial storage. This bulk storage may be included as part of an additional packaging and distribution system. For example, the discharge means may direct the coated particulate material to a bagging operation, including a metering of the finished product into the associate bag or package. The packages may have any desired size or configuration. Larger “bulk” storage sacks, capable of handling weight loads in the range of 1000 lbs. to 2000 lbs, which may then be supported on a shipping pallet, are presently considered economical. Alternatively, the finished product may be loaded, by front end loader or the like, into a truck and delivered in a relatively large volume. Again, other processing steps, packaging operations or storage methods may be utilized or added, as desired. The form of storage and packaging may dictate adjustments within the coating process so as to maintain the finished product in a relatively loose, particulate form, without the need for further processing to separate product that has adhered together during storage or packaging.

The coating processes as contemplated for use with the apparatus described above generally contemplates the coating of a particulate material while generally maintaining the particle size of the feed material within the final product. Further, a colorant may be added to the coating for adaptation of the particulate product to specific applications. In one specific example, the coating may be used for coloring crumb rubber particles for use as a filler material for artificial turf fields.

In one example, the coating is applied to the particulate in two or more stages. The first stage in this example includes a green color and the second stage coating is a topcoat of polyurethane. The green coating is preferably opaque, to hide the raw color of the crumb rubber. Preferably, the topcoat material is based on polyurethane pre-polymer based on methylene diphenyl diisocyanate (MDI), which uses moisture available from the first stage chemicals to initiate a curing or drying reaction. The polyurethane pre-polymer is combined with a reactive material or catalyst that creates a chemical reaction, drying the coating materials and encapsulating the particles.

The overall coating process of the present example may typically involve a number of steps, including the two stage application of the chemicals. First, the crumb rubber particulate material is loaded into a mixer, such as the mixing apparatus 10 as discussed above. The mixer 10 receives the particulate based on weight, which is generally associated with a desired volume of material in the mixing bowl. The batch weight of the particulate is determined within the mixer 10 by means of the four load cells 120 provided on the base of the support frame 94. The load cells generate signals that are calibrated by the system controller 80 to a weight of the material added to the bowl 38. It is contemplated that up to about 60% of the bowl volume is occupied by the particulate during processing of a single batch. The agitator 40 moves the particulate material within the bowl 30, while a quantity of the first stage coating chemicals is added. Again, measurement of the first stage coating chemicals is contemplated to be based on weight, determined by the load cells 120. A contemplated range for the weight of the first stage colorant, in the contemplated example, is 1% to 5% by weight of the colorant to the rubber particulate.

Mixing of the first stage materials and the particulate occurs for a defined period of time, contemplated to be in the rage of about 1 to 10 minutes. Upon completion of the mixing step, a specific weight of the second stage, polyurethane pre-polymer, in the range of 1% to 8% by weight of the second stage material to the existing materials (first stage chemical and the particulate combined). At the time the second stage chemicals are added, the first stage chemicals are coated on the particulate and are still in a relatively wet condition. Again, the mixer 10 proceeds to agitate the materials in the bowl as the second stage material is added. The agitation serves to add a further coating onto the particulate and uniformly spread the second stage coating throughout the mixer bowl 38. The chemical reaction, described in further detail below, between the first and second stage causes the color and the topcoat to dry, encapsulating the underlying particulate. The reactive catalyst may be provided as part of the first stage coating material or may be added to the pre-polymer material within the both. Once the drying process has completed to a desired extent, the mixer bowl 38 may be rotated to the discharge position (FIG. 4) and the coated/encapsulated particulate is removed by the discharge means, and the discharge conveyor moves the material away from the mixer for further processing.

As discussed above, one example the first stage coating material is contemplated to be an opaque (hiding) green color coat. A general formula for this first stage coating may be defined as follows:

| | |
|---|---|
| Water | 10-20% |
| Dispersant | 1-10% |
| Defoamer | 0.1-1% |
| pH control agent | 0.1-1% |
| Yellow Oxide Pigment | 25-50% |
| Titanium Dioxide | 1-10% |
| Phthalo Green Pigment | 2-10% |
| Rheology Modifier | 0.1-2% |
| Catalyst | 1-8% |
| Resin Solution | 2-12% |

The elements within the above general formula are provided for various purposes. For example, the dispersant is provided to aid in separation and suspension of the pigments and to provide stability such that the pigments do not settle and remain suspended. The purpose of the defoamer is to reduce the amount of foam generated during the pigment dispersion step and mixing. The pH control agent also aids in the pigment dispersion and in conjunction with rheology modifier provides viscosity stability within the finished product. The resin solution has the purpose of aiding the grinding of the pigment; that is, to reduce the particle size in order to develop the color within mixture. The yellow oxide pigment, titanium dioxide and phthalo green pigment provided to create the desired color (within the green example). The purpose of the catalyst is described above.

In addition to the above defined elements, a water based acrylic polymer may optionally be included in the color coat at levels from 5 to 20% (by weight). This acrylic polymer is intended to improve adhesion of the color to the particulate material, particularly to crumb rubber.

The second stage coating is contemplated in the present example to be polyurethane pre-polymer. The polyurethane pre-polymer is added to create a polyurethane topcoat that encapsulates the underlying particulate and colorant. Further, the combination of the pre-polymer and the reactive catalyst creates a chemical “drying” or curing that is sufficient to continue the coated material in a particulate form after mixing is complete.

Polyurethanes are in the class of compounds called reaction polymers. A urethane linkage is produced by reacting an isocyanate group, —N═C═O with alcohol (hydroxyl group: OH). Polyurethanes are generally produced by the polyaddition reaction of a polyisocyanate with a polyalcohol (polyol), often in the presence of catalyst(s) and other additives. When polyols are reacted with a molar excess of a polyisocyanate, the resultant product (pre-polymer) contains urethane linkages and isocyanate end groups—the latter of which will further react upon mixture with any molecule containing active hydrogen such as additional polyols or water.

The pre-polymer contemplated for the second stage additive to the present process example is intended to be reacted with ambient water within the first stage materials to form the final coating and is generally referred to as moisture curing polyurethane. Such moisture curing polyurethane pre-polymers will react with themselves, through the isocyanate groups, in the presence of moisture in the air. This moisture curing reaction can be accelerated by the addition of catalyst(s). The moisture curing reaction proceeds when isocyanate groups react with water, forming an amine with carbon dioxide being released. The resulting amine reacts with an additional isocyanate to form urea linkages. The polyurea functionality may, in turn, react with additional isocyanate groups to form a crosslinking branched network.

The curing process creates chemical bonds called “crosslink sites” throughout the coating matrix. The crosslink site density is affected by the polyurethane pre-polymer isocyanate functionality, the polyol selected in the preparation of the pre-polymer, and the catalyst used. The two main classes of catalyst that typically used are organometallics and amines. Organometallics are generally used to accelerate the reaction and formation of urethane linkages. Amines can promote the formation of urethane linkage, and are often used as well to promote the crosslinking through the moisture cure reaction, in essence creating a chemical drying.

Stability prior to application of the polyurethane pre-polymer is typically important to the contemplated process. The polyurethane pre-polymer is maintained in an inert environment that is free of moisture, since atmospheric moisture may start the crosslinking reaction. Polyurethane pre-polymers are generally packaged in tightly closed containers with a nitrogen blanket to remove trace amounts of air-borne moisture before sealing the package. If catalyst is present in the polyurethane pre-polymer and moisture is available the package stability may be lost. At the time of application of the coating to the particulate, the speed of the curing of the top coat may be an important factor for operational efficiencies. A catalyst may be used to promote the speed of curing process.

In the present example, the catalyst is provided in the (waterborne) latex color coating. This eliminates the step of handling and adding the catalyst separately. The polyurethane pre-polymer is introduced to the water and catalyst at the same time in a two step application process. Hence, in the first stage, the color coat containing water and catalyst is applied to the particulate substrate, followed by the addition of the polyurethane pre-polymer while first stage coating is still “wet”. A water stable 2,2-dimorpholinodiethylether amine or other catalyst in the same family is provided in the first stage color coating. The catalyst creates a curing mechanism and is separately added and thus promotes curing at the application stage, without risk to shelf life stability of the polyurethane pre-polymer. As the polyurethane pre-polymer is spread across the colored rubber particulate substrate, it comes into contact with the water and catalyst, and thus promoting fast and efficient curing.

As a variant to the overall process, the coating chemical may be applied in segregated, sub-stage amounts. As one example, a portion of the added water in the first stage may be added separately from the other chemical components. Hence, the curing process may be further controlled by a separate introduction of the water to the mixture. Additional drying may be created by forced air or other gases. In the mixing apparatus 10 as shown, the gases may be introduced into the bowl 38 through the blower 96, which is connected to openings within the cover plate 46 by the flexible hose 106.

In the following examples, a green-colored coating is provided on a rubber particulate material and mixed in a designated manner. The examples vary between the use of a chunk rubber particulate and a rubber particulate falling within the crumb rubber size designation. In each example, a mixing device essentially was utilized within the apparatus as shown and described herein to prepare the finished product.

### EXAMPLE 1

### Green Color Coating for Chunk Rubber

In the present example, the components of Tables 1 and 2 are combined to create a first coating material that is mixed according to the process described.

TABLE 1

| | Chemical | | Weight |
|---|---|---|---|
| Material Type | Name | Supplier (Location) | % |
| Water | — | — | 46.16 |
| Resin Solution | Joncryl 678 | BASF Corp (New | 8.85 |
| | | Jersey) | |
| Defoamer | DEE FO 3030 | Munzing Co. (New | 0.10 |
| | | Jersey) | |
| Colorant - Yellow | Chemik CB313 | Chemik Co. Ltd. (China; | 33.52 |
| Iron Oxide | | other distributor: Royale | |
| | | Pigments, (New Jersey)) | |
| Colorant - Titanium | Ti-Pure ® | DuPont Co. (Delaware) | 3.93 |
| Dioxide | R-706 | | |

The components of Table 1 are blended in a laboratory by combining the chemicals together for about 30 minutes at a blending rate of 1600 revolutions per minute (RPM). The blended combination is then placed at rest (0 RPM) for a period of about 2 minutes. The components shown in Table 2 are then added and blended for about 10 minutes at a rate of 300 RPM.

TABLE 2

| | Chemical | | |
|---|---|---|---|
| Material Type | Name | Supplier (Location) | Weight % |
| Defoamer | DEE FO 3030 | Munzing Co. (New | 0.10 |
| | | Jersey) | |
| Modifier | Rheolate ® 1 | Elementis Specialties, | 0.27 |
| | | Inc. (New Jersey) | |
| Catalyst | KA4 | ITWC, Inc. (Iowa) | 1.00 |
| Colorant - Phthalo | DG008-356 | Spectra Colorants | 6.07 |
| Green Pigment | | (South Carolina) | |

In the coating process, the mixer 10 is run with the internal agitator 40 rotating and the rubber particulate fee directed into the mixer bowl 38. The rate of rotation of the agitator 40 is set at a loading speed of about 15 RPM. The mixer bowl 38 is filled with 2,000 pounds (lbs) of chunk rubber as determined by the load cells 120. The rate of feed into the mixer 10 is relatively fast and is contemplated to take a total time of about 1 minute.

The mixer 10 in the present example is sized in the present example whereby the particulate load occupies about half of the internal volume of the bowl. This general volume range is considered advantageous for exposing the surface area of the particles during mixing. Using this range, a large mixer would be provided to batch process a greater load of particulate. As a further example, the mixer handling a 2000 lbs load of rubber may have a bowl with an internal volume of about 160 cubic feet. A mixer handling a load of rubber of 4000 lbs may have a volume of about 320 cubic feet. As discussed in other examples below, a mixer handling a batch load of 20 lbs may have a bowl volume of about 1.5 cubic feet. These volumetric numbers are provided as illustrative examples and are not considered limiting on the form of the mixer. Moreover, linear scaling of bowl volume is again not a specific requirement, but illustrative of preferred construction.

Upon determination of the desired load of rubber particulate by the load cells 120, the mixer bowl 38 is moved (rotated) from the feed position (FIG. 2) to the mixing position (FIG. 3) with the cover plate 46 engaged (arrow 52) over the opening 36. The rotation of the agitator 40 is adjusted to a color addition speed of about 10 RPM. The colorant material for the first coating in the formulas of Tables 1 and 2 is pumped into the mixer bowl 38 through one or more manifolds 48, with the load cells 120 measuring the total weight added to the bowl 38. For the batch prepared in the current example, 20 lbs of the first coating is added, which is 1% of the weight of the rubber particulate in the batch. The rate of pumping of the first coating into the bowl 38 is relatively quick, resulted in a total pumping time of about 30 seconds. The rubber and first coating material is then mixed by the agitator 40 with in the mixer bowl 38 for about 1 minute.

The addition of the second coating material, which is the pre-polymer, the mixer speed is set to an addition speed of about 10 RPM. The pre-polymer utilized in the present example is Lupranate 5080 obtained from BASF (New Jersey). The total weight of the coating materials in this example is 26 lbs. Hence, the total weight of the pre-polymer coating is 1.3% of the weight of the rubber material. The total pumping time to add the second coating pre-polymer to the mixer bowl 38 is about 90 seconds. After mixing the pre-polymer with the coated particle, a further quantity of the catalyst is added. This additional catalyst in the present example is about 3% of the weight of the first coating. (The particular KA4 catalyst provided is a 2,2, Dimorpholinodiethylether material.) The coated rubber, including the first coating, the pre-polymer and the additional catalyst is mixed until dry-to-touch, which occurred in about 22 minutes. It is contemplated that the final mixing time may range between about 15 to 30 minutes depending on color, catalyst amount, temperature and other ambient conditions. The “dry-to-touch” test in the present examples is performed by observing that there is no color transfer to a gloved hand when inserted into the mixture in the bowl (with the agitator not rotating, for safety concerns).

The addition of catalyst may be adjusted to control the overall reaction. It has been found that the addition of too much catalyst may result in a reduction of the durability of the coating, causing flaking or chipping of the coating. It is generally believed that this durability reaction is the result of a curing process that is too fast. Alternatively, too little catalyst may extraordinarily extend the curing time or result in the coating taking on an adhesive quality, creating conglomeration of the particulate. An additional factor in the process may also be the form and speed of the mixer.

Upon determining desired dryness in the Example 1, the agitator 40 within the mixer bowl 38 is adjusted to the discharge speed of about 15 RPM. The coated product is then discharged from bowl 38 (FIG. 4), taking about 3 to 5 minutes, including an inspection to make sure all project had been discharged. At this point, the product is moved away from the mixer 10 by the discharge conveyor 14. Upon full discharge, the mixer bowl 38 may be rotated back to the feed position (FIG. 2) and made ready for preparation of the next batch of feed material.

### EXAMPLE 2

### Green Color Coating for Crumb Rubber

The components of Tables 3 and 4 are combined in this example to create a first coating that is blended according to the process as described. In the prior example, the particulate is chunk rubber. In the current example, the particulate is smaller is size and falls within the classification of crumb rubber.

TABLE 3

| | Chemical | | |
|---|---|---|---|
| Material Type | Name | Supplier (Location) | Weight % |
| Water | — | — | 25.00 |
| Resin Solution | Joncryl 678 | BASF (New Jersey) | 4.54 |
| Dispersant | Tamol 731A | Dow Chemical | 0.40 |
| | | (Michigan) | |
| pH Modifier | MIPA (mono | Dow Chemical | 1.14 |
| | isopropanol | (Michigan) | |
| | amine) | | |
| Water | — | — | 1.14 |
| Defoamer | DEE FO 47J | Munzing Co. New | 0.02 |
| | | Jersey) | |
| Colorant - Yellow | Chemik CB313 | Chemik Co. Ltd. (China; | 34.09 |
| Iron Oxide | | other distributor: Royale | |
| | | Pigments, (New Jersey)) | |
| Colorant - Clay | ASP ® 172 | BASF (New Jersey) | 17.05 |
| Pigment | | | |

The coating components of Table 3 are prepared in a laboratory by combining the materials together for about 2 minutes at a blending rate of 500 RPM. The materials identified in Table 4 are then added to the combination and blended for about 30 minutes at a rate of 1400 RPM.

TABLE 4

| Material Type | Chemical Name | Supplier (Location) | Weight % |
|---|---|---|---|
| Water | — | — | 13.60 |
| Colorant - Phthalo | GN7 | Spectra Colorants | 3.00 |
| Green Pigment | | (South Carolina) | |
| Defoamer | DEE FO 3030 | Munzing Co. (New | 0.02 |
| | | Jersey) | |

In process, the internal agitator 40 is rotated at about 15 RPM within the mixer bowl 38. During the rotation, the bowl 38 is filled with 2,000 lbs of crumb rubber. The rate of feed into the mixer 10 results in a total feed time of about 45 seconds. Upon determination of the desired load of rubber particulate by the load cells 120, the mixer bowl 38 is rotated from the feed position (FIG. 2) to the mixing position (FIG. 3). The agitator 40 is then increased in speed to about 30 RPM. The first coat material resulting from the chemicals within Tables 3 and 4 is pumped into the mixer bowl 38 through manifolds 48, with the load cells 120 measuring the total weight added. In the current example, the first coat materials added is 40 lbs (or 2% of the weight of the rubber particulate). The pumping rate for the first coat material into the bowl 38 may occur is approximately 1 minute. The rubber and first coating material are then mixed within the bowl 38 for at least 1 minute to ensure proper coating of the particulate.

During the addition of the second coating, or pre-polymer, material, the mixer speed is set to about 10 RPM. The pre-polymer in the present example is QPZ 14, supplied by ITWC Inc. of Malcolm, Iowa. The total weight of coating materials added is 60 lbs (or about 3.0% of the weight of the rubber material). The total pumping time to add the second coating to the mixer bowl 38 is about 3 minutes. A catalyst is then added to the mixture. The catalyst in the present example is KA4 (from ITWC Inc. of Malcolm, Iowa). The total catalyst added is 1.6 lbs (or about 4% of the weight of the first coat material).

The rubber, first coating, pre-polymer material and catalyst is mixed in the mixer bowl 38 by the agitator 40 until dry-to-touch (as herein discussed), which may occur in about 25 minutes. Again, the final mixing time typically may range between about 20 to 30 minutes, depending on color, catalyst amount and temperature conditions.

Upon determining the desired dryness, the agitator 40 within the mixer bowl 38 is adjusted to the discharge speed of about 15 RPM. The coated product is then discharged from bowl 38 (FIG. 4) in about 2 to 3 minutes, including an inspection to make sure the entire product is discharged. The product is moved away from the mixer 10 by the conveyor. Upon full discharge, the mixer bowl 38 may again be rotated back to the feed position, ready for preparation of the next batch.

### EXAMPLE 3

### Green Color Coating for Crumb Rubber

The components of Tables 5, 6 and 7 were combined to create a first coating that is mixed with a crumb rubber particulate in the process described.

TABLE 5

| Material Type | Chemical Name | Supplier (Location) | Weight % |
|---|---|---|---|
| Water | — | — | 17.30 |
| Resin Solution | Joncryl 678 | BASF Corp. (New | 8.86 |
| | | Jersey) | |
| Dispersant | Tamol 731A | Dow Chemical | 0.29 |
| | | (Michigan) | |
| pH Modifier | MIPA | Dow Chemical | 0.77 |
| | | (Michigan) | |
| Defoamer | DEE FO 3030 | Munzing Co. (New | 0.05 |
| | | Jersey) | |

The coating components of Table 5 are prepared by combining the materials together for about 5 minutes at a blending rate of 600 RPM. The materials identified in Table 6 are then added to the combination and blended for about 30 minutes at a rate of 1400 RPM.

TABLE 6

| | Chemical | | |
|---|---|---|---|
| Material Type | Name | Supplier (Location) | Weight % |
| Colorant - Yellow | Chemik | Chemik Co. Ltd. (China; | 40.10 |
| Iron Oxide | CB313 | other distributor: Royale | |
| | | Pigments, (New Jersey)) | |
| Colorant - Titanium | Ti-Pure ® | DuPont Co. (Delaware) | 4.82 |
| Dioxide | R-706 | | |

Prior to the addition of the materials identified in Table 7, the blending speed is reduced to about 600 RPM. The components of Table 7 are added to the mixture and blended for about 10 minutes at a rate of 600 RPM. The resulting combination may then be used as the first coat colorant for the crumb rubber particulate.

TABLE 7

| | Chemical | | |
|---|---|---|---|
| Material Type | Name | Supplier (Location) | Weight % |
| Acrylic Polymer | Fulatex ® | HB Fuller (Minnesota) | 19.28 |
| Colorant - | PD-3802 GN7 | Spectra Colorants | 8.19 |
| Phthalo Green | | (South Carolina) | |
| Pigment | | | |
| Modifier | Rheolate ® 1 | Elementis Specialties, | 0.48 |
| (thickener) | | Inc. (New Jersey) | |
| Defoamer | DEE FO 3030 | Munzing Co. (New | 0.05 |
| | | Jersey) | |
| Catalyst | KA4 | ITWC, Inc. (Iowa) | 4.82 |

In process, the internal agitator 40 within the mixer 10 is rotated at about 15 RPM during receipt of the rubber particulate feed into the mixer bowl 38. The bowl 38 is sized for receipt of 2,000 lbs of crumb rubber, which may occur in about 45 seconds. Upon completion of the desired load, the mixer bowl 38 is moved to the mixing position (FIG. 3) and the agitator 40 rotated at about 30 RPM. The first coating material as defined in Tables 5, 6 and 7 is pumped into the mixer bowl 38, with the load cells 120 measuring the total weight added. In the present example, 40 lbs of the first coating material (or 2% of the weight of the rubber particulate) is added to the bowl in approximately 1 minute. The rubber and first coating material are then mixed for at least 1 minute to fully coat the particulate.

During the addition of the second coating material, the agitator 40 within the mixer 10 is rotated at about 10 RPM. The second coating material or pre-polymer selected in the present example is Lupranate 5230, as supplied by BASF (New Jersey). The total weight of pre-polymer added is 60 lbs (or 3% by weight of the rubber material). The total pumping time to add the pre-polymer is contemplated to be about 3 minutes. The catalyst in the present example is included within the first coating material and is reacted with the pre-polymer during mixing. The coated rubber and second coating/pre-polymer material is mixed until dry-to-touch (as herein discussed), which typically occurs in about 25 minutes. Again, the final mixing time may range between about 20 to 30 minutes, depending on color, catalyst amount, temperature and other ambient conditions.

Upon determining desired dryness, the agitator 40 within the mixer bowl 38 is adjusted to the discharge speed of about 15 RPM. The coated product is discharged from bowl 38 (FIG. 4) in about 3 minutes, including inspection time. The coated product is moved away from the mixer 10 and the mixer is prepared for processing a further batch.

The foregoing examples are defined for both chunk and crumb size rubber particles and result in an opaque green colored coating. Variations in the green color and in the opacity of the coating are possible. Other colors are also possible and are contemplated. Landscape and playground materials are known to be colored blue, yellow, green, red, silver, brown, khaki, mustard and black (among others). Chunk rubber or similar sized materials may be used in these environments, with any of the identified colors preferably applied as part of the first coating material in the process. Similar colors may be utilized to coat the crumb rubber or similar sized materials for typical applications in sports fields and playgrounds. These materials may also be fixed into mats or sheets by the additional application of an adhesive polymer to the dry (coated) particles.

### EXAMPLE 4

### Red Color Coating for Chunk Rubber

The components of Tables 8, 9 and 10 are combined to create a (brick) red coating and blended according to the process as described. In the present example, the blending is performed within a laboratory and then the resulting coating is applied in a mixer as otherwise contemplated herein.

TABLE 8

| Material Type | Chemical Name | Supplier (Location) | Weight % |
|---|---|---|---|
| Water | — | — | 17.00 |
| Resin Solution | Joncryl 678 | BASF (New Jersey) | 3.60 |
| pH Modifier | MIPA (mono | Dow Chemical | 0.80 |
| | isopropanol amine) | (Michigan) | |

The coating components of Table 8 are blended for about 5 minutes at a blending rate between 700 RPM. The materials identified in Table 9 are then added in the order specified and blended at the same rate for about 15 minutes. The blender speed is then increased to 900 RPM for about 45 minutes.

TABLE 9

| Material Type | Chemical Name | Supplier (Location) | Weight % |
|---|---|---|---|
| Defoamer | DEE FO 3030 | Munzing Co. (New | 0.01 |
| | | Jersey) | |
| Thickener | Kelzan ® S | CP Kelco (Oklahoma) | 0.29 |
| | Xanthan Gum | | |
| Colorant - Red | Chemik CB 130 | Chemik Co. Ltd. (China; | 56.00 |
| Iron Oxide | | other distributor: Royale | |
| | | Pigments, (New Jersey)) | |
| Defoamer | DEE FO 3030 | Munzing Co. (New | 0.04 |
| | | Jersey) | |

The blender is stopped (0 RPM) for about 2 minutes. As indicated in Table 10, additional water is added to the combination. The blender is set to a blend rate of 300 RPM. A catalyst is then added, along with a (further) quantity of defoamer.

TABLE 10

| Material Type | Chemical Name | Supplier (Location) | Weight % |
|---|---|---|---|
| Water | — | — | 19.25 |
| Defoamer | DEE FO 3030 | Munzing Co. (New | 0.01 |
| | | Jersey) | |
| Catalyst | KA4 | | 3.00 |

The total catalyst weight added is 3% of the total weight of the coating. The batch is mixed at the 300 RPM rate for about 10 minutes. The coating material is then ready for application to the chunk rubber.

Mixing of the chunk rubber particulate with the coating materials in the present example is performed in a mixer generally of the type shown, having lifting-type paddle blades with the mixer bowl. In the present example, the bowl is sized for 20 lbs of particulate and, as discussed above has an internal bowl volume of 1.5 cubic feet. Due to the size of the bowl and batch, a lower number of agitator blades are provided, as compared to the device illustrated in the present drawings (see, e.g., FIGS. 11-13). In the example, the mixer includes and agitator with four paddle arms with the blades on the ends of the arms positioned adjacent the bowl wall. (Hence, in the example mixer, the blades are not positioned at different radii, as in the figures.) The blades on the ends of the arms are formed an varying angles and provide a lift function to direct the material radially inward for exposing the particulate to the coating materials.

Chunk rubber (sized to about ¾ inch) is added to the mixer and with the agitator rotated at a speed of about 15 RPM. The first coating material according to the formula above is added to the rubber. The weight of the first coating is 1% of the weight of the rubber, or in the present batch about 2 lbs. The rubber and first coating are initially mixed for about 1 minute. The pre-polymer material is then added. The weight of the pre-polymer is 1.3% of the weight of the rubber. In the present example, the pre-polymer is 2.6 lbs of Lupranate 5080 (BASF (New Jersey)). Mixing is performed until dry-to-touch (as noted above).

### EXAMPLE 5

### Blue Color Coating for Chunk Rubber

The components of Tables 11, 12 and 13 were combined to create a blue colored coating that is blended according to the process as described.

TABLE 11

| Material Type | Chemical Name | Supplier (Location) | Weight % |
|---|---|---|---|
| Water | — | — | 24.36 |
| Resin Solution | Joncryl 678 | BASF (New Jersey) | 10.0 |
| Defoamer | DEE FO XHD 47J | Munzing Co. (New | 0.10 |
| | | Jersey) | |

The coating components of Table 11 are combined together for about 5 minutes at a blending rate between 640 RPM. The materials identified in Table 12 are then added to the combination and blended for 30 minutes at the same rate.

TABLE 12

| Material Type | Chemical Name | Supplier (Location) | Weight % |
|---|---|---|---|
| Colorant - | Ti-Pure ® R-706 | DuPont Co. (Delaware) | 45.0 |
| Titanium | | | |
| Oxide | | | |
| Thickener | Kelzan ® S | CP Kelco (Oklahoma) | 0.17 |
| | Xanthan Gum | | |

The blending is stopped (0 RPM) and the components in Table 13 are added. The combination is blended for about 10 minutes at a rate of 300 RPM. The coating material is then ready for application to the chunk rubber.

TABLE 13

| Material Type | Chemical Name | Supplier (Location) | Weight % |
|---|---|---|---|
| Defoamer | DEE FO 3030 | Munzing Co. (New | 0.10 |
| | | Jersey) | |
| Colorant - Blue | Spectra DB 153-002 | Spectra Colorants | 17.27 |
| | | (South Carolina) | |
| Catalyst | KA4 | ITWC, Inc. (Iowa) | 3.00 |

Mixing of the chunk rubber particulate with the coating materials in the present example is performed in a mixer generally of the type shown, having lifting-type paddle blades with the mixer bowl. Again, in the present example the bowl is sized for 20 lbs of particulate, although other size mixers are possible (as in the other examples), with scaling up of the coating materials to match the quantities of particulate to be mixed. Chunk rubber (sized to about ¾ inch) is added to the mixer and with the agitator rotated at a speed of about 15 RPM. The first coating material according to the formula above is added to the rubber. The weight of the first coating is 1% of the weight of the rubber, or in the present batch about 2 lbs. The rubber and first coating are initially mixed for about 1 minute. The pre-polymer material is then added. The weight of the pre-polymer is 1.3% of the weight of the rubber. Again, in the present example, the pre-polymer is 2.6 lbs of Lupranate 5080 (BASF (New Jersey)). Mixing is performed until dry-to-touch (as noted above).

### EXAMPLE 6

### Brown Color Coating for Chunk Rubber

The components of Tables 14, 15 and 16 are combined to create a brown colored coating and then mixed with chunk rubber particles.

TABLE 14

| Material Type | Chemical Name | Supplier (Location) | Weight % |
|---|---|---|---|
| Water | — | — | 14.00 |
| Dispersant | HC 850-32 | Harcross Chemicals, | 0.67 |
| | | Inc. (Kansas) | |
| pH Modifier | MIPA (mono | Dow Chemical | 0.80 |
| | isopropanol | (Michigan) | |
| | amine) | | |
| Colorant -- Carbon | N326 | Sid Richardson | 6.31 |
| Black | | (Texas) | |

The coating components of Table 14 are combined together for about 30 minutes at a blending rate of 1400 RPM. The materials identified in Table 15 are then added with the blender continuing to run at 1400 RPM for 30 minutes.

TABLE 15

| | Chemical | | |
|---|---|---|---|
| Material Type | Name | Supplier (Location) | Weight % |
| Water | — | — | 5.00 |
| Resin Solution | Joncryl 678 | BASF (New Jersey) | 4.00 |
| Colorant - Red Iron | Chemik | Chemik Co. Ltd. (China; | 45.75 |
| Oxide | CB 130 | other distributor: Royale | |
| | | Pigments, (New Jersey)) | |

The components of Table 16 are added after a 2 minute rest (0 RPM). The blending rate is then increased to 300 RPM for 10 minutes.

TABLE 16

| Material Type | Chemical Name | Supplier (Location) | Weight % |
|---|---|---|---|
| Water | — | — | 19.50 |
| Defoamer | DEE FO 3030 | Munzing Co. (New | 0.03 |
| | | Jersey) | |
| Modifier | Rheolate ® 1 | Elementis Specialties, | 0.94 |
| | | Inc. (New Jersey) | |
| Catalyst | KA4 | ITWC, Inc. (Iowa) | 3.00 |

Mixing of the chunk rubber particulate with the coating materials in the present example is performed in a mixer having lifting-type paddle blades with the mixer bowl. In the present example the bowl is sized for 20 lbs of particulate (with scaling up of the coating materials to match the quantities of particulate to be mixed in larger mixers being possible). Chunk rubber is added to the mixer and with the agitator rotated at a speed of about 15 RPM. The first coating material according to the formula above is added to the rubber. The weight of the first coating is 1% of the weight of the rubber, or in the present batch about 2 lbs. The rubber and first coating are initially mixed for about 1 minute. The pre-polymer material is then added. The weight of the pre-polymer is 1.3% of the weight of the rubber. Again, in the present example, the pre-polymer is 2.6 lbs of Lupranate 5080 (BASF (New Jersey)). Mixing is performed until dry-to-touch (as noted above).

### Evaluative Testing

Using the examples provided, further testing was performed on the durability of the coating. A test for evaluating durability is defined as follows. A 100 grams (0.22 lbs) portion of coated and cured rubber particulate is added to a 200 grams (0.44 lbs) quantity of water. The coated particulate is a placed within a 1 pint container and shaken for 5 minutes in a paint shaker-type mixing machine. The particulate is then separated from the water and the water evaluated for appearance. A rating scale is provided for the water rubbing evaluation test:

| Evaluation | Rating |
|---|---|
| Clear water | 0 |
| No color tint/with small particles | 0+ |
| Slight visible color tint | 1/2 |
| Colored tint (varying intensity) | 1 to 3 |
| Intensely colored and transparent | 4 |
| Intensely colored and opaque | 5 |

In the defined test, the wet rubbing of the particulate may cause abrasion of the particles against each other and affect the coating adhesion and durability. The amount of color in the water is correlated to the abrasion resistance, with the lower rating being the more resistant the material.

In Table 16 there is a provided a comparative testing of the coatings of Examples 4, 5 and 6 when processed in a mixer of the type shown in the present drawings and another “standard” mixer. In the present test, the “standard” batch of coated particulate is prepared in a cement mixer having a rotating bowl with agitating vanes on the inside surface. The results of the comparison are shown.

TABLE 16

| | | Mixing/Drying Time | Durability |
|---|---|---|---|
| Color | Mixer Type | (minutes) | Rating |
| Red | Paddle | 15 | 0+ |
| Red | Standard | 30 | 3 |
| Blue | Paddle | 17 | 0+ |
| Blue | Standard | 27 | 4 |
| Brown | Paddle | 17 | 0+ |
| Brown | Standard | 25 | 1/2 |

As shown, the use of a standard mixer resulted in a significant increase in the time to reach dry-to-touch (measured from the addition of the pre-polymer to the coated particulate). This comparison utilized the same formulation for the initial coating and the same quantities of particulate, coating and pre-polymer. In addition, the durability of the coating was significantly better when process in the paddle mixer as compared to the standard mixer. It is believed that the improvement is the result of the mixing operation in the paddle mixer. As contemplated by the present disclosure, the agitator is formed by a plurality of arms having an angles paddle blades, with the blades preferably having a lifting function resulting from the blade form and position. The mixer thus repeatedly exposes the surface of the particulate both to the coating materials and to the ambient environment. This paddle agitation creates a more efficient drying and further results in an increase in durability of the coating material.

The present disclosure includes a description and illustration of a number of exemplary embodiments. It should be understood by those skilled in the art from the foregoing that various other changes, omissions and additions may be made therein, without departing from the spirit and scope of the invention, with the invention being identified by the foregoing claims.

1. An apparatus for coating a particulate material comprising:
a mixer having a defined mixing chamber;
means for directing a quantity of particulate material into the mixing chamber;
an agitator provided in the mixing chamber, the agitator having
a shaft mounted for rotation within the mixing chamber,
a plurality of arms projecting radially outward from the shaft, and
a plurality of paddle blades, one of the blades positioned on the ends of each of the projecting arms; the blades formed such that during rotation of the shaft the particulate material in the mixing chamber is directed in a rotational direction, a radially inward direction and an axial direction within the mixing chamber;
a material feed system communicating with the mixing chamber, the feed system having
a coating feed for delivery of a first coating material into the mixing chamber during rotation of the agitator and mixing by the rotating paddle blades;
a polymer feed for delivery of a polymer material into the mixing chamber during rotation of the agitator and mixing of the coated particulate material;
a reaction feed for delivering a reaction material for causing a chemical drying reaction between the colorant feed and the polymer feed creating an encapsulated particulate material; and
means for discharging the encapsulated particulate material from the mixing chamber.

2. An apparatus as in claim 1, wherein the coating feed and the reaction fee are combined so as to deliver the first coating material and the reaction material in to the mixing chamber for mixing with the particulate material.

3. An apparatus as in claim 1, wherein the plurality of agitator blades are directed at varying angles with respect to the agitator shaft.

4. An apparatus as in claim 1, wherein the agitator blades are positioned at multiple radial positions relative to the agitator shaft.

5. An apparatus as in claim 1, wherein the polymer feed material comprises polyurethane pre-polymer.

6. An apparatus as in claim 1, wherein the reaction material comprises a catalyst for reacting with the polymer material to create the chemical drying.

7. An apparatus as in claim 1, wherein the mixing chamber is defined by a elongated mixer bowl having a longitudinal axis and at least a portion of an inside surface if the bowl defining a cylindrical surface surrounding the axis.

8. An apparatus as in claim 7, wherein the shaft of the agitator is aligned along the axis of the bowl.

9. An apparatus as in claim 8, wherein at least a portion of the blades are positioned adjacent the inside surface of the bowl and are rotated in a closely spaced relationship with the inside bowl wall.

10. A method of coating a particulate material comprising the steps of:
providing a mixing chamber;
feeding a particulate material into the mixing chamber;
agitating the particulate material within the mixing chamber;
mixing a first coating material with the particulate feed material in the mixing chamber to create a first coating on the particulate material;
mixing a reaction catalyst with the coated particulate material;
mixing a pre-polymer material with the first coating and the coated particulate material, the catalyst and pre-polymer reacting to create a chemical drying of the mixed first coating, catalyst and pre-polymer; and
forming a polyurethane coating encapsulating the particulate material.

11. A method as in claim 10, wherein step of mixing the reaction catalyst with the first coating material occurs prior to the mixing of the first coating material with the particulate material.

12. A method as in claim 11, further comprising the step of mixing an additional reaction catalyst while mixing the pre-polymer material with the coated particulate material.

13. A method as in claim 10, wherein the agitating of the particulate material and the mixing of the first coating material with the particulate material are performed by a plurality of agitator blades rotating within the mixing chamber.

14. A method as in claim 13, wherein the agitator blades are directed at varying angles with respect to a rotating agitator shaft.

15. A method as in claim 14, wherein the agitator blades are positioned at multiple radial positions relative to the agitator shaft.

16. A method as in claim 15, wherein the mixing chamber is defined by a elongated mixer bowl having a longitudinal axis and at least a portion of an inside surface if the bowl defining a cylindrical surface surrounding the axis.

17. A method as in claim 16, wherein the shaft of the agitator is aligned along the axis of the mixer bowl.

18. A method as in claim 17, wherein at least a portion of the blades are positioned adjacent the inside surface of the bowl and are rotated in a closely spaced relationship with the inside bowl wall.
